(19) United States
(12) Patent Application Publication
(10) Pub. No.: US 2015/0176438 A1
(43) Pub. Date: Jun. 25, 2015

(54) CAM FOLLOWER FOR THE VALVE GEAR OF AN INTERNAL COMBUSTION ENGINE

(71) Applicant: Schaeffler Technologies GmbH & Co. KG, Herzogenaurach (DE)

(72) Inventors: Jurgen Kretschmer, Furth (DE); Michael Schober, Vestenbergsgreuth (DE); Melanie Stark, Herzogenaurach (DE)

(73) Assignee: SCHAEFFLER TECHNOLOGIES GMBH & CO. KG, Herzogenaurach (DE)

(21) Appl. No.: 14/412,264

(22) PCT Filed: May 23, 2013
(86) PCT No.: PCT/EP2013/060604

§ 371 Date: Dec. 31, 2014

(30) Foreign Application Priority Data
Jul. 3, 2012 (DE) 102012211525.0

(51) Int. Cl. F01L 1/18; F16H 53/06

(52) U.S. Cl. CPC F01L 1/185; F16H 53/06

(57) ABSTRACT

For a cam follower for the valve drive of an internal combustion engine, including a housing in the form of a lever body (2) and a cam roller (6) arranged between two parallel lever walls (3, 4) of the housing (2), wherein the cam roller includes an outer ring (7) and an inner ring (8) arranged therein, and is mounted on a bolt (5) retained on the lever cheeks (3, 4), the invention proposes that inwards extending guidance sections (9, 10) are formed on the lever body (2) for the axial positioning of the outer ring (7) and for the guidance thereof in the circumferential direction.

### FIELD OF THE INVENTION

The invention relates to a cam follower for the valve train of an internal combustion engine, with a housing in the shape of a lever body and a cam roller that is arranged between two parallel lever walls of the housing and comprises an outer ring and an inner ring located in this outer ring, wherein it is supported on a pin held on the lever walls so that it can rotate.

### BACKGROUND

Such a cam follower is known from the publication DE 10 2008 036 056 A1. This is formed as a finger lever that is supported with one end section by a ball and socket joint on a support element arranged stationary in the internal combustion engine and actuates a gas-exchange valve with its other end section. The cam roller is arranged in the middle section of the rocker arm between the lever walls forming the side walls and requires, for the support of its outer ring and its inner ring opposite the pin, a set of roller bodies with roller bodies formed as needles. These are arranged within the inner ring that is surrounded by the outer ring. Therefore, for the needles, the outer raceway profile is in the inner ring and the inner raceway profile is on the pin. The needles have a somewhat smaller axial length than the outer ring and the inner ring, that is, they are similarly almost as wide as these rings.

If the cam follower is to be used for a disk cam design, that is, a design of the valve train with the cam piece arranged on the camshaft so that it can move in the axial direction, as is known, e.g., from the publication DE 10 2004 002 290 A1, an axially narrower outer ring that projects significantly from the lever housing is required for the cam follower. For a very narrow construction of the outer ring, however, the pressure that occurs during operation on this component increases, which can result in the fatigue strength falling below the required fatigue strength.

Designs of cam followers are also known whose inner ring is supported on the pin so that it can rotate in a sliding configuration, that is, without a set of roller bodies. Such a sliding inner ring without roller bodies, however, disadvantageously results in increased friction during operation.

### SUMMARY

The invention is based on the objective of achieving a solid design of the valve train with cam followers that is suitable for the disk cam system. Here, each cam follower should be formed with a narrow outer ring, that is, with an outer ring of smaller axial length so that significantly lower contact pressures occur in the lever region during operation than in previously known cam followers.

This objective is met according to the invention in that guide regions extending inward are formed on the lever body for the axial positioning of the outer ring and for its guidance in the circumferential direction. The inner ring can then be positioned on the two lever walls in the axial direction and guided in the circumferential direction. The outer ring has a smaller axial length than the inner ring.

The solution according to the invention thus provides a lever body that allows a stepped guidance of two rings of different widths or axial lengths. The outer ring is positioned by the inner sides of the guide regions extending inward, while the inner ring is positioned by the inner sides of the lever walls.

For the cam follower, the outer ring and the inner ring can be formed as one integral component. It is also possible, however, that the outer ring and the inner ring are two individual components, wherein the outer ring is mounted on the inner ring.

The inner ring can be supported with a set of roller bodies on the pin so that it can rotate and the set of roller bodies can be constructed with roller bodies formed as needles, wherein these roller bodies have the same axial length as the inner ring. This arrangement produces a larger contact zone in the contact of the inner ring with the similarly wide needles and thus smaller pressure values can be achieved there.

### BRIEF DESCRIPTION OF THE DRAWING

An embodiment of the invention is shown in the drawing and is described in more detail below. Shown are:

FIG. 1 a cam follower according to the invention in perspective view,

FIG. 2 the cam follower according to the invention in a side view in the axial direction of the rings, and

FIG. 3 the cam follower according to the invention in a section along line III-III of FIG. 2.

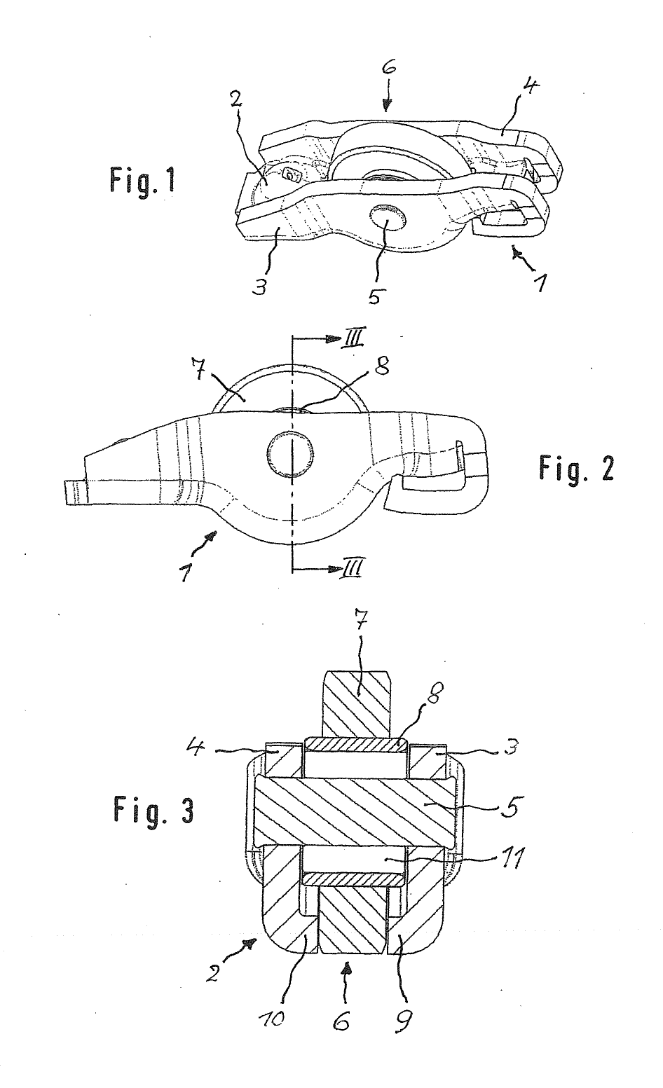

### DETAILED DESCRIPTION OF THE PREFERRED EMBODIMENTS

A cam follower 1 for a valve train of an internal combustion engine is provided with a housing in the shape of a lever body 2 with two parallel lever walls 3 and 4 arranged at a distance to each other. The cam follower is formed as a finger lever in whose middle region a pin 5 is arranged and held in flush holes of the two lever walls 3 and 4. Between the lever walls 3 and 4 there is a cam roller 6 in the lever body 2, wherein this cam roller is supported on the pin 5 so that it can rotate. This roller includes an outer ring 7 and an inner ring 8 that can rotate on the pin 5.

According to the invention, two guide regions 9 and 10 that extend inward are formed on the lever body 2. In FIG. 3 they are located on the lever ends of the lever walls 3 and 4. With their inner surfaces, they position the outer ring 7 and form guide surfaces for it in its rotation in the circumferential direction. The width of the outer ring 7, that is, its axial length, is smaller relative to the inner distance measure of the lever walls 3 and 4 of the lever body 2.

The inner ring 8 is supported in the lever body 2 so that it can rotate with a set of roller bodies on the pin 5, whose roller bodies are needles 11. The axial lengths of the inner ring 8 and the needles 11 are equal size and correspond to the inner distance measure of the lever walls 3 and 4. Therefore, the inner ring 8 that is wider relative to the outer ring 7 is positioned by the inner surfaces of the lever walls 3 and 4 and guided in the circumferential direction.

### LIST OF REFERENCE NUMBERS

1 Cam follower
2 Lever body
3 Lever wall
4 Lever wall
5 Pin
6 Cam roller
7 Outer ring
8 Inner ring
9 Guide region
10 Guide region
11 Needle

1. A cam follower for a valve train of an internal combustion engine, comprising a housing forming a lever body a cam roller arranged between two parallel lever walls of the housing an outer ring an inner ring located in said outer ring, it is the inner ring being supported on a pin held on the lever walls guide regions extending inward are formed on the lever body for axial positioning and guidance of the outer ring in a circumferential direction.

2. The cam follower according to claim 1, wherein the inner ring is positioned on the two lever walls in an axial direction and guided in the circumferential direction.

3. The cam follower according to claim 1, wherein the outer ring has a smaller axial length than the inner ring.

4. The cam follower according to claim 1, wherein the outer ring and the inner ring are formed as one integral component.

5. The cam follower according to claim 1, wherein the outer ring and the inner ring are two individual components, and the outer ring is mounted on the inner ring.

6. The cam follower according to claim 1, wherein the inner ring is supported with a set of roller bodies on the pin so that it can rotate.

7. The cam follower according to claim 6, wherein the set of roller bodies is constructed with the roller bodies formed as needles, and the roller bodies have a same axial length as the inner ring.
